(19) United States
(12) Patent Application Publication
(10) Pub. No.: US 2005/0281481 A1
(43) Pub. Date: Dec. 22, 2005

(54) Method for medical 3D image display and processing, computed tomograph, workstation and computer program product

(76) Inventor: Lutz Guendel, Erlangen (DE)

Correspondence Address: HARNESS, DICKEY & PIERCE, P.L.C., P.O.BOX 8910, RESTON, VA, 20195, US

(21) Appl. No.: 11/144,830

(22) Filed: Jun. 6, 2005

(30) Foreign Application Priority Data
Jun. 7, 2004 (DE) 10 2004 027 708.7

(51) Int. Cl. G21K 1/12; H05G 1/60

(52) U.S. Cl. 382/276

(57) ABSTRACT

A medical imaging diagnostic method can be simultaneously simplified and improved within the context of medical 3D image display and processing. To this end, the method for medical 3D image display and processing includes prescribing an observer position, a search beam and a pixel value for a surface of a 3D evaluation volume. To simplify and improve matters, a first pixel on the search beam is determined on the basis of the pixel value. The search beam is expanded to an extended search region on the far side of the first pixel, and a second pixel on the search beam in the extended search region is determined as a pixel which is alternative or additional to the first pixel on the basis of an extended pixel value range with one or more extended pixel values. At least one of the first pixel and the second pixel is then displayed.

The present application hereby claims priority under 35 U.S.C. §119 on German patent application number DE 10 2004 027 708.7 filed Jun. 7, 2004, the entire contents of which is hereby incorporated herein by reference.

### FIELD

The invention generally relates to a method for medical 3D image display and processing. For example, the method may include steps wherein: a 3D data volume is provided, and an observer position, a search beam and a pixel value are prescribed for the 3D data volume. The invention also generally relates to a computed tomograph, to a workstation and to a computer program product.

### BACKGROUND

Modern medical imaging methods normally provide images in digital form. To this end, the first step within the framework of “primary applications” is data recording and the provision of the digital data in the course of data construction.

In particular, computed tomography images are provided in digital form and can thus be processed further directly in a computer or in a workstation. From the original images, it is possible to obtain images in a new orientation with two-dimensional or three-dimensional display (2D display, 3D display) in order to provide a suitable overview for the examiner. Such displays are intended, in particular, to form the basis of subsequent diagnosis within the context of a monitor examination.

The advantages of computed tomography result, in particular, from the fact that there are no superposition problems as in the case of conventional radiography. Further, computed tomography provides the advantage of undistorted display regardless of different magnification factors associated with the recording geometry in radiography.

In the meantime, a series of different procedures have become established for 3D image display and processing. For these procedures, a computed tomograph has suitable control elements, e.g. a computer mouse or other control media. A workstation for image display and processing of computed tomography images is equipped with appropriate software in the form of a computer program product and a user interface on a screen with appropriate control elements to which functions are assigned.

Computed tomography (CT) first of all normally provides two-dimensional sectional images of the transverse plane of a body to be examined as direct recording plane. In this case, the transverse plane of a body is arranged essentially at right angles to the longitudinal axis of a body. Two-dimensional sectional images in a plane at an angle that has changed in comparison with the transverse plane and/or those which are calculated with a different, particularly broader, layer thickness than the original layer thickness are normally called multiplanar reformations (MPR).

One option which is fundamental to diagnosis is interactive inspection and evaluation of the image volume, usually under the control of an appropriate control element. The examiner can use such control elements—in a similar manner to guiding a sound head in ultrasound—to feel his way to anatomized structures and pathological details and can move forward and backward to select that image in which a detail of interest is presented most clearly, that is to say by way of example is displayed with the highest contrast and the largest diameter.

An extended form of two-dimensional display involves putting together layers (slabs) of arbitrary thickness from thin layers. For this, the term “sliding thin slab” (STS) has become established. All 2D displays have the advantage that the computed tomography values are displayed directly and without corruption. Any interpolations or averages formed over a plurality of layers are negligible in this case. Thus, there is always simple orientation in the evaluation volume, which is also called the volume of interest (VOI), and in the associated 3D data volume and also explicit interpretability of the image values. This type of monitor examination is work-intensive and time-consuming, however.

By contrast, the most realistic presentation of the evaluation volume possible can be achieved through three-dimensional display of the evaluation volume. Although 3D image display and processing is normally the prerequisite for specific elaboration of diagnostically relevant details, the latter examination is normally performed in a 2D display.

In the case of 3D image display and processing, a 3D data volume is normally provided which is taken as a basis for displaying the evaluation volume. The examiner preferably prescribes an observer position from which he wishes to observe the evaluation volume. In particular, the examiner normally has a search beam at his disposal.

In this example, a two-dimensional image is calculated which is at right angles to the search beam and is intended to convey a spatial impression. To construct such a display pixel by pixel (also: voxel—acronym for volume element) in the image plane, all CT values along the search beam through the 3D data volume need to be taken into account and assessed for each beam from the observer to the respective pixel. The examiner normally prescribes a pixel value, e.g. a contrast value, which he selects in suitable fashion for displaying a pixel. The repetition (inherent to the method) of this process shows the examiner a collection of pixels corresponding to the search beam on the basis of the prescribed pixel values within the context of a CT value profile for the search beam, that is to say shows a 3D display of the body region/evaluation volume of interest (VOI).

All 3D displays may, that is to say within the context of a secondary application, be designed either as a central projection or as a parallel projection. For a parallel projection, “maximum intensity projection” (MIP) or generally “volume rendering” (VR) is particularly suitable.

In the case of MIP, the pixel with the highest CT value is determined in the projection direction along the search beam. In that case, the pixel value thus corresponds to the maximum CT value on the search beam. In the case of VR, not just a single pixel is chosen for each individual search beam coming from the observer's eye, but rather all CT values along the search beam can, with suitable weighting, deliver a pixel as a contribution to the resulting image. Freely selectable and interactively alterable transfer functions are used to assign opacity and color to each pixel value.

It is thus possible, by way of example, to select normal soft tissue to be largely transparent, contrasted vessels to be slightly opaque and bones to be very opaque. Preferable central projections may be attained, by way of example, by “surface shaded display” (SSD) or by “perspective volume rendering” (pVR) (or else “virtual endoscopy”). Accordingly, there is the SSD or else the pSSD used in virtual endoscopy.

SSD is threshold-based surface display, where a pixel is prescribed by prescribing a pixel value in the form of a threshold. For every search beam through the present 3D data volume, that pixel is determined at which the prescribed pixel value in the form of a threshold value is reached or exceeded for the first time as seen by the observer. One basic difference between SSD and VR is that in the case of SSD only one threshold is defined, but the surface is displayed opaque.

In the case of VR, on the other hand, a plurality of threshold regions are defined and these are assigned colors and transparencies. “Virtual endoscopy” is intended to permit a perspective view of the close surroundings of the virtual “endoscope head”. Unlike in the case of the actual endoscope, structures can be observed from different directions and while moving. “Fly-throughs”, which are intended to give the impression of a virtual flight through the VOI, are possible. This is not only esthetic and instructive, but also may be of diagnostic value. In particular, a “vessel view” method can be used to render the interior of an evaluation volume visible.

All of the methods for 3D image display and processing determine a final pixel on the search beam on the basis of a suitably prescribed pixel value. This ultimately results in the display of a surface of interest for the object to be examined in the evaluation volume. In many cases, however, in addition to the surface of the object to be examined, the tissue a few centimeters behind the surface is of interest.

In this regard, it is currently necessary to resort to additional 2D displays, e.g. within the context of the MPR or STS, in parallel with the 3D image display and processing. This is found to be very time-consuming and complicated for operation, since it is sometimes necessary to change from the 3D display to the 2D display several times. Thus, it is necessary to give up the advantageously realistic presentation within the context of the 3D image display in order to elaborate diagnostically relevant details just within the context of the 2D display.

What would be desirable, however, is targeted elaboration of relevant details within the context of the 3D display. This would achieve a 3D display which is entirely adequate for diagnostic examination.

### SUMMARY

An object of an embodiment of the invention may include specifying a method and/or an apparatus for medical 3D image display and processing, where the diagnosis within the context of the 3D display of medical images is at least one of simplified and improved in terms of diagnostic examination.

A method of at least one embodiment of the invention may include:
a 3D data volume is provided for an evaluation volume,
an observer position, a search beam and a pixel value are prescribed for a surface of the evaluation volume,
a first pixel on the search beam is determined on the basis of the pixel value,
the search beam is expanded to an extended search region on the far side of the first pixel, and
a second pixel on the search beam in the extended search region is determined as a pixel which is alternative or additional to the first pixel on the basis of an extended pixel value range with one or more extended pixel values,
the first pixel and/or the second pixel is/are displayed.

An embodiment of the invention includes the consideration that within the context of the 3D image display and processing, there should be an option for looking behind displayed areas/surfaces. This is because the observer's view extends, within the context of the method described at the outset, just as far as said area/surfaces, since a prescribed pixel value indicates that a pixel which is already final is determined.

By contrast, the present method provides for a first pixel to be determined. The first pixel is then used as a starting point for expanding the search beam to an extended search region on the far side of the first pixel. Next, a second pixel is determined in the extended search region. The examiner is thus able to look behind a surface which, in line with the prior art, is final and, in line with the new concept, is determined on a provisional basis at first.

The method provides for the second pixel in the extended search region to be determined on the basis of an extended value range for a pixel value, i.e. on the basis of an extended pixel value range. The second pixel is thus possibly determined on the basis of a new pixel value, which does not need to match the original pixel value. In this way, it is possible to refine or improve the targeted diagnosis of relevant details in the extended search range.

An embodiment of the invention includes insight that targeted diagnosis becomes possible within the context of 3D display by virtue of joint access being provided for displaying surfaces and depth information within the context of medical 3D image display and processing. Joint display of surfaces and depth information in a 3D display mode represents fundamental renewal which allows a multiplicity of diagnostic approaches. In particular, it becomes possible to elaborate diagnostically relevant details in targeted fashion actually within the context of a 3D display.

Preferably, the extended search region is prescribed interactively or automatically. The examiner can determine the extended search region himself. It may also be desirable for the examiner just to indicate a certain diagnostic situation and for an automatically prescribed search region to appear on the basis of certain empirical values.

If appropriate, the examiner may also be provided with a number of preferable, possibly automatically determined, search regions within the context of a menu selection. This prevents an extended search region from being chosen to be too small, which would mean that too little depth information were then available. Secondly, it prevents an extended search region from turning out to be too large, so that proximity to a region with high contrast, e.g. a part of the skeleton or bone region, is avoided. This is because vessels filled by the skeleton or with contrast agent are normally structures which are distinguished from their surroundings by particularly high levels of contrast and would therefore be able to mask the details which are actually to be examined. Depending on the diagnostic situation, it may thus be advantageous to prescribe an extended search region which is specifically tuned and quantified for the diagnostic situation.

Preferably, the search beam is parameterized in the extended search region. Parameterization of the search beam is advantageous for computer processing and quantification of the extended search region.

According to variants of embodiments of the invention, the extended pixel value range may contain, depending on application, a single, a plurality of or a weighting for extended pixel values, for example. Hence, a pixel value may be indicated in the form of a threshold value, for example.

Another option is to specify a number amounting to a plurality of pixel values in the form of staggered threshold values. Finally, a pixel value range may be in the form of a weighting for a multiplicity of pixel values. As a result, particularly in the extended search range, a wide variety of details may simultaneously contribute to an image display as pixels.

Preferably, the extended pixel value range is prescribed interactively or automatically. An extended pixel value range should have been chosen in balanced fashion such that depth information is provided in suitable fashion. The values (e.g. contrast values) in a pixel value range, that is to say in a selection of pixel values, should not be too low in order to avoid a lack of depth information and should secondly not be too high in order to avoid proximity to an excessively high contrast region, for example in the form of a bone or in the form of a vessel filled with contrast agent.

One particular advantage is interactive or automatic selection of the second pixel as alternative or additional pixel. Thus, by way of example, it is possible to implement an automatic search for a lesion in the method. A lesion is generally to be understood to mean any abnormal structure or change of structure, for example in an organ, particularly on account of an injury or an illness. A lesion can often be described and characterized very precisely in terms of its shape and size. The automatic search for lesions has provision for a computer-automated search function on the basis of a particular geometric structure which is characteristic of the lesion. By way of example, this would allow rapid differentiation between diagnostically important findings and the “false positive” results.

Provision is preferably made for the first pixel to be displayed with the pixel value. The second pixel with the one or more extended pixel values may preferably be displayed additionally in the same image or in parallel therewith in a further image. In the case of this development, it is thus only the first pixel or only the second pixel or both which contribute(s) to the 3D image display. By way of example, an MIP display is appropriate here.

Within the context of another particularly preferred development, provision is made for holding and display of the second pixel with the one or more extended pixel values in a pixel lens. A pixel lens is also called a voxel lens. The second pixel is thus produced as soon as it enters the region of a voxel lens which can be moved by the examiner.

It has also been found that the method explained above can advantageously be supplemented by additional functions which simplify diagnosis. Thus, one particularly preferred development of the method has provision for output of maximum and/or minimum and/or mean values taking into account the extended search region. In this case, it is necessary to take into account actually measured CT values of the extended search region, in particular.

Another advantageous provision is output of a distribution for pixel values taking into account the extended search region. In this case, actually measured CT values need to be taken into account in the extended search region, in particular. A distribution may be in the form of a histogram, for example.

It has been found that the concept explained above can be implemented particularly effectively in terms of the 3D image display within the context of a virtual endoscopy. Such virtual endoscopic views, which are also called endoluminal views, are perspective VR or perspective SSD in practice. A primary area of use for this technology is anatomical structures which are also accessible to endoscopes. Examples of these include the bronchial tree, larger vessels, the colon and the paranasal sinus system. In addition, it is also used in regions such as renal cisternae and in the gastrointestinal region, which are not directly accessible to endoscopes.

The concept explained above makes provision for the method to be developed particularly within the context of coloscopy, bronchoscopy or cisternoscopy.

This is done by effecting medical image display and processing of images, particularly computed tomography or magnetic resonance tomography images, of a colon or of a bronchial tree or of a cisterna within the context of the method explained.

The concept explained above is found in one development to be particularly useful for a method which takes as its starting point a 3D data volume obtained using a contrast agent. Preferably, contrast agent is added to the aforementioned structures, in particular. The contrast agent used may be air, CO₂, N₂, O₂, water or another suitable contrast agent.

The method for medical image display and processing is particularly advantageously implemented in the form of an imaging method in computed tomography. Equally, however, it is also possible to implement it for data volumes obtained using other modalities, e.g. within the context of magnetic resonance tomography (MRT) or positron emission tomography (PET). The 3D data volume may also be obtained within the context of a three-dimensional ultrasound examination, for example.

An embodiment of the invention achieves the object for the apparatus by way of a computed tomograph or a magnetic resonance tomograph which has control elements for carrying out the method steps of the method.

For the apparatus, an embodiment of the invention also produces a workstation for image display and processing of computed tomography or magnetic resonance tomography images which has control elements for carrying out the method steps of the method explained above. The workstation may be advantageous for nonbiopsy applications, in particular. It is preferably used for monitor examination.

A control element is to be understood to include, in particular, a software method/device and/or a hardware method/device individually or in combination which can be used to execute or control one of the aforementioned method steps.

An embodiment of the invention also produces a computer program product for image display and processing of computed tomography or magnetic resonance tomography images which has program modules for the method steps of the method explained above.

### BRIEF DESCRIPTION OF THE DRAWINGS

Example embodiments of the invention are described below with reference to the drawings. Specifically, in the drawings:

FIG. 1 shows an outlined procedure within the context of a preferred embodiment of a method for 3D image display and processing in computed tomography, with a 3D data volume being shown schematically; and

FIG. 2 shows a flowchart of the preferred embodiment of the method for medical 3D image display and processing.

### DETAILED DESCRIPTION OF THE EXAMPLE EMBODIMENTS

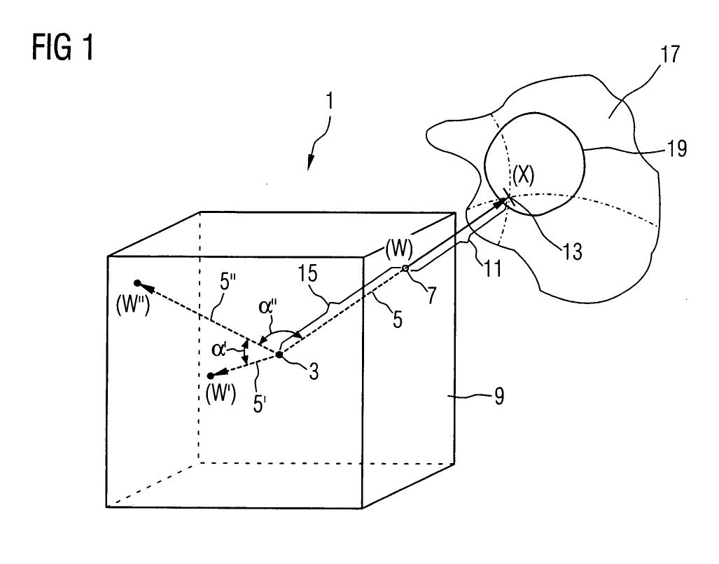

FIG. 1 schematically illustrates a procedure within the context of a particularly preferred embodiment of the method for 3D image display and processing in computed tomography using the example of the virtual endoscopy. The virtual endoscopy is intended to map a perspective view of the close surroundings of a virtual endoscope head and is used successfully for examining a colon, a bronchial tree or vessels, for example. The algorithms used for VR or SSD allow the colon wall or bronchial wall to be viewed in high quality.

For calculation, the high level of contrast difference between an air-filled interior and the surrounding tissue is utilized in this case. The VR-opacity and color functions are usually set such that the transition from intestinal, bronchial and vessel interiors to the surrounding tissue—that is to say the intestinal wall, the bronchial wall or the vessel wall—is shown opaquely. What is particularly informative and diagnostically often very important is to observe the structures moving and from different directions, which cannot normally be achieved with the endoscope or the operational microscope. In practice, this involves flights through the volume—also called “fly-throughs”—which convey the impression of a virtual flight through the tissue body region.

FIG. 1 schematically shows a 3D data volume 1 which has been provided. The data volume 1 has, in particular, a multiplicity of pixels (voxels) which each have an associated pixel value. An example of a distinguished pixel is the observer position 3, for example. The observer position 3 is prescribed in the course of the method.

In addition, a search beam 5 coming from the observer position 3 is prescribed. In ordinary methods, the search beam is continued up to such a pixel 7 as has a prescribed pixel value W. Such a pixel value W may be indicated in the form of a threshold, for example, which may correspond to a contrast value (shown schematically here) for a colon in the form of an intestinal wall 9, for example. The intestinal wall 9 is found by virtue of the search beam 5 assuming its prescribed pixel value W instead of the pixel 7 in the direction shown in FIG. 1. This was preceded by the 3D data volume 1 being scanned using other search beams 5′ and 5′ with variation of a solid angle α′, α″. In this process, the examiner thus uses a workstation or a computed tomograph to search for an intestinal wall 9 which is characterized by the pixel value W, W′ or W″.

In contrast to the previous practice, the present concept in at least one embodiment now allows a tissue to be displayed behind a surface/area, in the present example case behind the intestinal wall 9. To this end, in contrast to previous practices, the pixel 7 is determined merely as a first, provisional pixel 7 on a search beam 5 on the basis of the pixel value W. The search beam 5 is then expanded to an extended search region 11 on the far side of the provisional pixel 7. Next, a second, optional pixel 13 is determined in the extended search region 11.

In the case of the particular example embodiment shown in FIG. 1, the optional pixel 13 has an associated extended pixel value X within the context of an extended pixel value range (not shown in more detail). In the case of this example embodiment, the examiner has indicated X as an extended pixel value in order to search for a lesion behind the intestinal wall 9. In this case, the extended pixel value X has been chosen in a manner which is characteristic of the lesion being sought.

In the example of CT colonography, it is of interest, by way of example, whether in the virtual endoscope a polyp-like structure has its interior filled with air or with contrast agent or air particles and can thus be identified as a stool remainder without a diversion via an MPR display and can therefore be ignored in the diagnosis. In addition, in the case of positive findings, e.g. as a result of fat components which are held being identified or in the case of enrichment with a given contrast agent, the polyp-like structure can be diagnosed in differentiated fashion. When examining a bronchial tree, the extent and structure of a carcinoma would be of interest, for example, which could be on the far side of the bronchial wall. In that case, the reference symbol 9 would need to be assigned to a bronchial wall. In line with the directional concept explained here, a voxel in the form of the pixel 13 behind the surface in the form of an intestinal wall 9 or another wall is thus evaluated as additional information.

Simultaneous 3D image display and processing together with depth information is found to be valuable particularly when the body part represented by the 3D data volume is a moving body part. It may thus be very difficult to aspirate a pulmonary tumor, for example, since firstly a bronchial wall is very thin and secondly the position thereof is constantly altered by the breathing movement. A pulmonary tumor situated behind the bronchial wall can be aspirated very well and particularly reliably using the present concept, however, even when it is not situated as close to the bronchial wall. This is because the present concept provides depth information, in the present example embodiment within the scope of the extended search region 11.

In the example present embodiment, an extended search region 11 is suitably parameterized. Hence, a suitably extended search region 11 should be in the range between 1 and 2 cm in the case of the coloscopy. Such a distance measure is a preferable distance measure in the intestinal region.

When the concept explained is used within the context of the bronchoscopy, the behavior may be different. In that case, it may be advantageous to define the extended search region 11 a long way down into the lung. It is also advantageous to define an extended search region as a percentage proportion of the provisional search region 15. In the case of the cisternoscopy, other criteria again may be relevant.

In each case, the extended search region 11 should be parameterized such that the extended search region 11 can be quantified in a manner which is advantageous for the respective application. The display of the provisional pixel 13 as part of a CT image display may preferably be done within the context of an MIP, which can be displayed separately from the original endoluminal display or else together in superposed form. A selectable threshold can be used to detect contrast agent, for example. Crossing of the threshold, i.e. in the region of the coloscopy, e.g. detection of stool filled with contrast agent, may then be effected through coloring of the surface displayed in the virtual endoscopy.

A further refinement of an example embodiment has provision for a plurality of threshold values and display in different colors. In yet another refinement of an example embodiment, the actual CT values between a lower and an upper threshold can be evaluated and can be displayed in color-coded form. Depending on expediency, extended pixel values in the extended search region 11 may then be weighted. In this way, it would be possible to display all pixels in the extended search region 11 using a different weighting.

In the embodiment explained in FIG. 1, only the provisional pixel 7 with its pixel value W and the optional pixel 13 with its extended pixel value X are recorded. In the case of the monitor examination, the examiner displays the intestinal wall 9. If required, he can use a pixel lens—a voxel lens—to display the optional pixel 13 with the optional pixel value X as part of a region 17 situated behind the intestinal wall.

It has been found to be particularly advantageous with this type of application of the concept explained for a space on the far side of the intestinal wall 9 to be automatically searched for lesions 19. By way of example, it is thus possible to search for a structure having the appearance of a polyp by searching the space on the far side of the intestinal wall 9 for geometrically spherical or circular structures. Such a circular structure as an example of a lesion 19 is shown as part of the region 17 in the embodiment shown in FIG. 1.

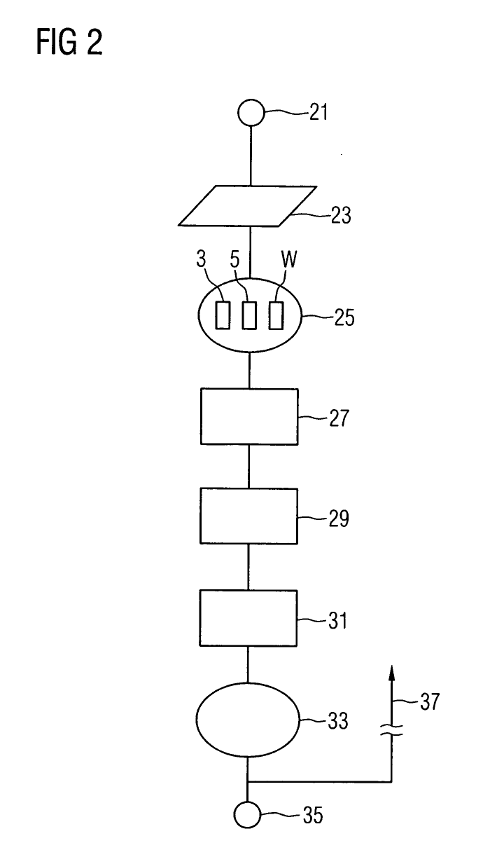

FIG. 2 shows a flowchart of an example embodiment of the method for medical 3D image display and processing. When the method has started 21, a 3D data volume is provided in method step 23. This may be a data volume 1 as shown in FIG. 1. Next, an observer position, a search beam and a pixel value are prescribed in method step 25. These may be an observer position 3 as shown in FIG. 1, a search beam 5 as shown in FIG. 1 and a pixel value W as shown in FIG. 1.

In method step 27, a provisional pixel on the search beam is then determined on the basis of the pixel value. This may be a provisional pixel 7 as explained in FIG. 1. In method step 29, the search beam is expanded to an extended search region on the far side of the provisional pixel. This may be a search region 11 as explained in FIG. 1. In method step 31, the optional pixel in the extended search region is determined. This may be an optional pixel 13 from FIG. 1, for example.

Before the end 35 of the method, the extended search region is evaluated as additional depth information, for example in addition to or in parallel with the 3D display, in method step 33. Suitable steps of the method can be repeated in a step 37 until the further pixels have been processed.

A medical imaging diagnostic method can be simultaneously simplified and improved within the context of medical 3D image display and processing. To this end, an example embodiment of the present concept takes as its starting point a method for medical 3D image display and processing which has the following method steps: a 3D data volume 1 is provided, an observer position 3, a search beam 5 and a pixel value W are prescribed for the 3D data volume 1. To simplify and improve matters, the concept has provision for: a provisional pixel 7 on the search beam 5 being determined on the basis of the pixel value W, the search beam 5 being expanded to an extended search region 11 on the far side of the provisional pixel 7, and an optional pixel 13 being determined in the extended search region 11.

Any of the aforementioned methods may be embodied in the form of a system or device, including, but not limited to, any of the structure for performing the methodology illustrated in the drawings.

Further, any of the aforementioned methods may be embodied in the form of a program. The program may be stored on a computer readable media and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, such as floppy disks (trademark), cassette tapes, and removable hard disks; media with a built-in rewriteable non-volatile memory, such as memory cards; and media with a built-in ROM, such as ROM cassettes.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for medical 3D image display and processing, comprising:
prescribing an observer position, a search beam and a pixel value for a surface of a 3D evaluation volume;
determining a first pixel on the search beam on the basis of the pixel value;
expanding the search beam to an extended search region proximate to the first pixel; and
determining a second pixel on the search beam in the extended search region as a pixel which is alternative or additional to the first pixel on the basis of an extended pixel value range with one or more extended pixel values; and
displaying at least one of the first pixel and the second pixel.

2. The method as claimed in claim 1, further comprising at least one of interactive and automatic prescribing of the extended search region.

3. The method as claimed in claim 1, further comprising parameterization of the search beam in the extended search region.

4. The method as claimed in claim 1, wherein the extended pixel value range contains one, a plurality of or a weighting for extended pixel values.

5. The method as claimed in claim 4, further comprising at least one of interactive and automatic prescribing of the extended pixel value range.

6. The method as claimed in claim 4, further comprising at least one of interactive or automatic selection of the second pixel as alternative or additional pixel.

7. The method as claimed in claim 1, wherein the displaying includes displaying at least one of the first pixel with the pixel value and the second pixel with the one or more extended pixel values.

8. The method as claimed in claim 1, wherein the displaying includes holding and displaying the second pixel with the one or more extended pixel values in a pixel lens.

9. The method as claimed in claim 1, wherein at least one of maximum, minimum and mean values are output, taking into account the extended search region.

10. The method as claimed in claim 1, wherein a distribution for pixel values are output, taking into account the extended search region.

11. The method as claimed in claim 1, wherein the method for medical image display and processing is an imaging method in at least one of computed tomography and magnetic resonance tomography.

12. The method as claimed in claim 1, wherein the 3D image display takes place in the form of a virtual endoscopy.

13. The method as claimed in claim 1, wherein the method is for medical image display and processing of images of a colon.

14. The method as claimed in claim 1, wherein the method is for medical image display and processing of images of a bronchial tree.

15. The method as claimed in claim 1, wherein the method is for medical image display and processing of images of a cisterna.

16. The method as claimed in claim 1, wherein the 3D data volume is obtained using a contrast agent.

17. At least one of a computed tomograph magnetic resonance tomography, including control elements for performing the method as claimed in claim 1.

18. A workstation for image display and processing of at least one of computed tomography and magnetic resonance tomography images, including control elements for performing the method as claimed in claim 1.

19. A computer program product for image display and processing of at least one of computed tomography and magnetic resonance images, including program modules for performing the method as claimed in claim 1.

20. The method as claimed in claim 1, further comprising at least one of interactive or automatic selection of the second pixel as alternative or additional pixel.

21. The method as claimed in claim 7, wherein the displaying includes holding and displaying the second pixel with the one or more extended pixel values in a pixel lens.

22. An apparatus for medical 3D image display and processing, comprising:
means for prescribing an observer position, a search beam and a pixel value for a surface of a 3D evaluation volume;
means for determining a first pixel on the search beam on the basis of the pixel value;
means for expanding the search beam to an extended search region proximate to the first pixel; and
means for determining a second pixel on the search beam in the extended search region as a pixel which is alternative or additional to the first pixel on the basis of an extended pixel value range with one or more extended pixel values; and
means for displaying at least one of the first pixel and the second pixel.

23. The apparatus as claimed in claim 22, for image display and processing of at least one of computed tomography and magnetic resonance tomography images.

24. The apparatus as claimed in claim 22, wherein the 3D data volume is obtained using a contrast agent.
